(19) United States
(12) Patent Application Publication
(10) Pub. No.: US 2004/0248007 A1
(43) Pub. Date: Dec. 9, 2004

(54) Positive electrode for alkaline battery and alkaline battery using the same

(76) Inventors: Hiromi Tamakoshi, Kyoto-shi (JP); Hisanori Sugahara, Ono-shi (JP); Shinichi Iwamoto, Takarazuka-shi (JP); Kiyoshi Sato, Osaka (JP)

Correspondence Address: Jonathan P. Osha, Osha & May L.L.P., Suite 2800, 1221 McKinney St., Houston, TX, 77010, US

(21) Appl. No.: 10/865,567

(22) Filed: Jun. 8, 2004

(30) Foreign Application Priority Data
Jun. 9, 2003 (JP) 2003-163257
Jan. 28, 2004 (JP) 2004-019128

(51) Int. Cl. H01M 4/32; H01M 4/52; H01M 4/50

(52) U.S. Cl. 429/223; 429/224; 252/182.1

(57) ABSTRACT

An alkaline battery is configured using a positive electrode for an alkaline battery containing a positive active material that contains nickel oxyhydroxide, wherein a surface of the nickel oxyhydroxide is covered with a cobalt compound, an electric potential of the nickel oxyhydroxide is in a range of 0.320 to 0.375 V with respect to a Hg/HgO reference electrode, and a content of the nickel oxyhydroxide is at least 35 wt % with respect to the positive active material. According to this configuration, an alkaline battery can be provided, which has excellent heavy-load discharging characteristics and storage characteristics at a high temperature, and has less degradation of characteristics. Furthermore, it is desirable to combine this positive electrode with a negative electrode containing minute zinc particles in at least a predetermined proportion.

### BACKGROUND OF THE INVENTION

1. Field of the Invention

The present invention relates to a positive electrode constituting an alkaline battery that is excellent in heavy-load discharging characteristics and storage characteristics and keeps excellent heavy-load discharging characteristics even after storage at a high temperature, and an alkaline battery using the positive electrode.

2. Description of the Related Art

Recently, for the purpose of a high output, an alkaline battery using nickel oxyhydroxide has been developed (JP2002-8650A), and it also has been considered that nickel oxyhydroxide is mixed with manganese dioxide that is a positive active material for a conventional alkaline battery (JP2003-234107A).

However, nickel oxyhydroxide is likely to be self-decomposed, so that an alkaline battery using nickel oxyhydroxide as a positive active material has poor storage characteristics compared with a conventional alkaline battery using manganese dioxide as a positive active material.

More specifically, nickel oxyhydroxide is self-decomposed to generate oxygen, which oxidizes a negative electrode made of zinc to decrease a discharging capacity. This tendency becomes conspicuous particularly during storage at a high temperature, resulting in a remarkable decrease in discharging characteristics of a battery after storage. Furthermore, as shown in JP2003-234107A, the electric potential of nickel oxyhydroxide is higher than that of manganese dioxide, so that a separator made of vinylon or vinylon/rayon used in a conventional alkaline battery is oxidized during storage at a high temperature, and discharging performance also is degraded for this reason. Thus, in an alkaline battery using nickel oxyhydroxide as a positive active material, it is desired that the stability of nickel oxyhydroxide is enhanced so as to be comparable to that of manganese dioxide.

In order to solve the above-mentioned problems, a method for dissolving zinc in nickel oxyhydroxide in a solid state also has been proposed (JP2002-75354A). However, in the case of enhancing heavy-load discharging characteristics, the above method is insufficient, and the stability of nickel oxyhydroxide needs to be enhanced further.

More specifically, in order to substantially enhance heavy-load discharging characteristics, the enhancement of the characteristics of a negative electrode as well as a positive electrode (e.g., decrease in size of a zinc particle that is a negative active material, etc.) also is required. However, minute zinc particles are likely to be oxidized, so that they are oxidized easily with a small amount of oxygen generated by self-decomposition of nickel oxyhydroxide. In particular, the discharging capacity is decreased remarkably after storage at a high temperature.

### SUMMARY OF THE INVENTION

In one or more embodiments, the present invention provides a positive electrode for an alkaline battery capable of constituting an alkaline battery that is excellent in heavy-load discharging characteristics and storage characteristics and keeps excellent heavy-load discharging characteristics even after storage at a high temperature, and an alkaline battery using the positive electrode.

In one or more embodiments, the present invention provides a positive electrode for an alkaline battery using at least nickel oxyhydroxide as a positive active material, wherein a surface of the nickel oxyhydroxide is covered with a cobalt compound, an electric potential of the nickel oxyhydroxide is in a range of 0.320 to 0.375 V with respect to a Hg/HgO reference electrode, and a content of the nickel oxyhydroxide in the positive electrode is at least 35 wt % with respect to the positive active material.

Furthermore, in one or more embodiments, the present invention provides a positive electrode for an alkaline battery using at least nickel oxyhydroxide and manganese dioxide as a positive active material, wherein the nickel oxyhydroxide forms a solid solution with 0.01 to 5 wt % of zinc and 0.01 to 2 wt % of cobalt, a surface of the nickel oxyhydroxide is covered with a cobalt compound in an amount of 0.5 to 8 parts by weight in terms of cobalt conversion with respect to 100 parts by weight of nickel oxyhydroxide, an electric potential of the nickel oxyhydroxide is in a range of 0.330 to 0.375 V with respect to a Hg/HgO reference electrode, and a content of the nickel oxyhydroxide is in a range of 35 to 95 wt % with respect to the positive active material.

Furthermore, in one or more embodiments, the present invention provides an alkaline battery including a negative electrode using zinc as a negative active material and a positive electrode using at least nickel oxyhydroxide as a positive active material, wherein the zinc of the negative electrode contains at least 10 wt % of particles with a particle size of 10 to 75 μm, a surface of the nickel oxyhydroxide of the positive electrode is covered with a cobalt compound, an electric potential of the nickel oxyhydroxide is in a range of 0.320 to 0.375 V with respect to a Hg/HgO reference electrode, and a content of the nickel oxyhydroxide is at least 35 wt % with respect to the positive active material.

Furthermore, in one or more embodiments, the present invention provides an alkaline battery including a negative electrode using zinc as a negative active material and a positive electrode using at least nickel oxyhydroxide as a positive active material, wherein the zinc of the negative electrode contains at least 20 wt % of particles with a particle size of 10 to 75 μm, an electric potential of the nickel oxyhydroxide is in a range of 0.320 to 0.375 V with respect to a Hg/HgO reference electrode, and a content of the nickel oxyhydroxide in the positive electrode is 35 to 95 wt % with respect to the positive active material.

Furthermore, in one or more embodiments, the present invention provides an AA alkaline battery comprising a negative electrode containing zinc as a negative active material and a positive electrode containing at least nickel oxyhydroxide as a positive active material, wherein pulse discharging for flowing a pulse current of 2 A for 2 seconds is performed at an interval of 30 seconds at 23° C., the number of pulse discharging required for a voltage of the battery to decrease to 1.0 V while the pulse current of 2 A is flowing is at least 130, and a decrease in voltage is at most 30 mV when the battery is stored in a homoiothermal chamber of 60° C. for 20 days.

These and other advantages of the present invention will become apparent to those skilled in the art upon reading and understanding the following detailed description with reference to the accompanying figures.

### BRIEF DESCRIPTION OF THE DRAWINGS

FIG. 1 is a partial vertical cross-sectional view schematically showing an example of an alkaline battery according to the present invention.

### DESCRIPTION OF THE PREFERRED EMBODIMENTS

According to embodiments of the present invention, an alkaline battery can be provided, which is excellent in heavy-load discharging characteristics and storage characteristics and keeps excellent heavy-load discharging characteristics even after storage at a high temperature.

According to one embodiment of the present invention, by using nickel oxyhydroxide having the above-mentioned particular electric potential, the generation of oxygen involved in decomposition of nickel oxyhydroxide is prevented, and the decrease in storage characteristics due to the oxidation of zinc is suppressed, whereby the problems caused by using nickel oxyhydroxide as a positive active material can be prevented. On the other hand, the enhancement of stability of a positive active material enables the use of zinc with a smaller particle size as a negative active material, whereby the heavy-load discharging characteristics of an alkaline battery can be enhanced further.

As a positive active material, although the above-mentioned particular nickel oxyhydroxide may be used alone, the following excellent effects can be obtained by using a combination of nickel oxyhydroxide and another active material such as manganese dioxide.

In general, a positive electrode of an alkaline battery is produced by filling a mold with a positive mixture (mixed material) composed of a positive active material, a conductive aid, a binder such as polytetrafluoroethylene, and a small amount of electrolyte solution, and obtaining a ring-shaped molding (ring-shaped positive mixture) in the mold. Thereafter, the molding thus obtained is placed in a positive can under pressure. Nickel oxyhydroxide generally is excellent in flowability in a spherical shape. Therefore, in the case where nickel oxyhydroxide is used as a positive active material, a positive mixture is likely to scatter during filling with respect to a mold and pressure-forming, and the positive mixture dogs a gap of the mold to make it difficult to pull the molded ring-shaped positive mixture from the mold. Furthermore, the molded ring-shaped positive mixture is not strong, so that it is likely to collapse while being placed in a positive can under pressure. However, when manganese dioxide is mixed with nickel oxyhydroxide, since the flowability of manganese dioxide is poor in a lump, the above-mentioned problem can be prevented. The mixed weight ratio between nickel oxyhydroxide and manganese dioxide preferably is 95:5 to 35:65 (nickel oxyhydroxide : manganese dioxide) for the following reason. By setting the proportion of nickel oxyhydroxide to be 35 wt % or more, heavy-load discharging characteristics can be enhanced substantially compared with a conventional alkaline battery using manganese dioxide. On the other hand, by setting the proportion of nickel oxyhydroxide to be 95 wt % or less, i.e., by setting the proportion of manganese dioxide to be 5 wt % or more, the strength of a mixture is enhanced remarkably to improve productivity. The proportion of manganese dioxide desirably is 10 wt % or more, and that of nickel oxyhydroxide desirably is 45 wt % or more.

Manganese dioxide to be mixed with nickel oxyhydroxide is not particularly limited. However, in order to enhance heavy-load characteristics, those which have a large BET specific surface area may be used, and those which have a BET specific surface area of 40 m²/g or more is preferable. If the BET specific surface area exceeds 100 m²/g, the moldability of a positive mixture is decreased, so that those which have a BET specific surface area in a range of 40 to 100 m²/g may be selected. An example of such manganese dioxide can be obtained, for example, as follows.

In the process of forming manganese dioxide by an electrolytic method, a titanium compound such as titanium sulfate or a zirconium compound such as zirconium sulfate is allowed to be present in a solution in which manganese sulfate is dissolved, whereby titanium or zirconium is dissolved in a solid state in electrolytic manganese dioxide thus formed. The content of titanium or zirconium in this case preferably is in a range of 0.01 to 3 wt %. An active material that can be mixed with nickel oxyhydroxide is not limited to manganese dioxide, and other positive active materials such as silver oxide may be used.

According to one embodiment of the present invention, it is desirable that nickel oxyhydroxide whose surface is coated with a cobalt compound is used. Nickel oxyhydroxide has poor stability and has its conductivity decreased due to discharging. However, when the surface of nickel oxyhydroxide is coated with a cobalt compound having conductivity, the conductivity of nickel oxyhydroxide is enhanced, and the polarization during heavy-load discharging is reduced. Therefore, a discharging efficiency during heavy-load discharging can be enhanced.

Furthermore, when the surface of nickel oxyhydroxide is coated with a cobalt compound, the contact between nickel oxyhydroxide and an electrolyte solution is inhibited to suppress a reaction therebetween. Therefore, the stability of nickel oxyhydroxide can be enhanced further.

It is preferable that the amount of the cobalt compound covering the surface of nickel oxyhydroxide is 0.5 to 8 parts by weight in terms of cobalt conversion with respect to 100 parts by weight of nickel oxyhydroxide. By setting the coating amount of the cobalt compound with respect to nickel oxyhydroxide to be 0.5 parts by weight or more, the above-mentioned effect is exhibited more clearly, and by setting the coating amount to be 8 parts by weight or less, the discharging capacity can be prevented from being decreased. Examples of the cobalt compound covering the surface of nickel oxyhydroxide include cobalt oxide, cobalt hydroxide, cobalt oxyhydroxide, and the like. There is no particular limit to the cobalt compound as long as it is changed to a compound having conductivity during an assembly process of a battery. Since cobalt oxyhydroxide has high conductivity, it is desirable that cobalt oxyhydroxide is formed previously on the surface of nickel oxyhydroxide.

Furthermore, it is preferable that nickel oxyhydroxide used in the present invention forms a solid solution with zinc and cobalt. Zinc and cobalt dissolved in a solid state in nickel oxyhydroxide are not participated in a discharging reaction; however, they have effects of controlling the physical properties of nickel oxyhydroxide such as a particle shape, a half-value width, and the like of nickel oxyhydroxide, and suppressing a change in shape and physical properties of particles due to storage at a high temperature. In particular, the dissolution of zinc in a solid state is preferable for enhancing high-temperature storage characteristics, and the dissolution of cobalt in a solid state is preferable for enhancing the conductivity of nickel oxyhydroxide. The dissolved amount of zinc in nickel oxyhydroxide preferably is 0.01 to 5 wt %, and the dissolved amount of cobalt preferably is 0.01 to 2 wt %.

Furthermore, the electric potential of nickel oxyhydroxide used in the present invention is adjusted to be in a range of 0.320 to 0.375 V with respect to a Hg/HgO reference electrode. More specifically, in the case where the electric potential of nickel oxyhydroxide is lower than 0.320 V with respect to a Hg/HgO reference electrode, the oxidation degree of nickel oxyhydroxide as well as the voltage of an alkaline battery are decreased. Therefore, sufficient heavy-load discharging characteristics are not obtained.

The case where the electric potential of nickel oxyhydroxide is higher than 0.375 V means that nickel oxyhydroxide is not homogeneous and contains a large amount of unstable high-order nickel oxide exceeding 3 valences. Therefore, in the case where such nickel oxyhydroxide is stored at a high temperature, it is likely to be reduced. Furthermore, oxygen gas is generated due to the self-decomposition nickel oxyhydroxide based on the reduction reaction to oxidize a negative electrode, whereby heavy-load discharging characteristics are degraded. Furthermore, when nickel oxyhydroxide has a high electric potential, a separator is oxidized, and a decomposition product may inhibit a battery reaction. More preferably, the electric potential of nickel oxyhydroxide may be 0.360 V or less. When the electric potential is equal to or more than 0.330 V, more excellent heavy-load characteristics are expected.

An example of a method for controlling the electric potential of nickel oxyhydroxide to be in the above range includes controlling a drying condition during a production process of nickel oxyhydroxide. Although an appropriate range of the drying condition is varied depending upon the presence/absence of an element to be dissolved in a solid state in nickel oxyhydroxide, in the case of nickel oxyhydroxide obtained by dissolving zinc and cobalt in a solid state in a range of 0.01 to 5 wt % and 0.01 to 2 wt %, respectively, by performing dry treatment for 20 to 60 hours in a temperature range of 85° C. to 105° C., the electric potential can be adjusted in the above range. More specifically, nickel oxyhydroxide used in the present invention is obtained, for example, by oxidizing nickel hydroxide for an alkaline storage battery coated with a cobalt compound with an oxidant such as sodium hypochlorite, sodium peroxydisulfate, hydrogen peroxide, and the like, and washing the resultant nickel hydroxide with water, followed by drying. By performing drying under the above conditions, nickel oxyhydroxide is stabilized without adversely influencing other characteristics, and its electric potential can be adjusted in a range of 0.320 to 0.375 V with respect to a Hg/HgO reference electrode. Furthermore, during this process, the cobalt compound present on the surface also is stabilized, and can be present stably in the form of cobalt oxyhydroxide having conductivity.

In the case where the temperature during drying is lower than 85° C., a drying time needs to be prolonged, so that the productivity is degraded. When the temperature during drying is higher than 105° C., the cobalt compound covering the surface of nickel oxyhydroxide is oxidized more than necessary, whereby discharging characteristics are likely to be decreased. Furthermore, in the case where the drying time is shorter than 20 hours, nickel oxyhydroxide is not sufficiently stabilized, and even after the completion of drying, the reduction of unstable high-order nickel oxide in nickel oxyhydroxide proceeds in a battery, so that storage characteristics of the battery may be degraded. When the drying time is too long, the productivity is degraded, and the reduction amount of nickel oxyhydroxide becomes too large, which is not preferable.

Furthermore, as another method for setting the electric potential of nickel oxyhydroxide to be in the above range, there is a method for aging a positive mixture. More specifically, by storing a positive mixture containing a positive active material, a conductive aid, an electrolyte solution, and a binder at 20° C. to 80° C. for 1 to 60 days, the electric potential of even nickel oxyhydroxide, which is out of the range defined in the present invention, can be set to be in the above range. In the case where the temperature during aging is lower than 20° C., it takes a long period of time for aging. In the case where the temperature during aging is higher than 80° C., the reduction reaction occurs rapidly, so that it is difficult to control a reduction amount. Furthermore, since the reduction does not proceed sufficiently when the storage period is less than one day, it is difficult to adjust the electric potential of nickel oxyhydroxide in the above range. In the case where the storage period is more than 60 days, the productivity is degraded, which is not preferable.

As described above, as is apparent from the fact that the electric potential of nickel oxyhydroxide can be adjusted in a preferable range due to aging of a positive mixture, according to the present invention, the electric potential of nickel oxyhydroxide may be adjusted in the above range during production of a positive electrode, in addition to the use of nickel oxyhydroxide whose electric potential is adjusted to be 0.320 to 0.375 V with respect to a Hg/HgO reference electrode before preparation of a positive mixture.

For production of a positive electrode, a conductive aid, an electrolyte solution, a binder, and the like are mixed with a positive active material composed of a mixture containing nickel oxyhydroxide and manganese dioxide to form a positive mixture, and filling a mold with the positive mixture to mold it into a ring shape. Examples of the conductive aid include graphite, Ketjen Black, acetylene black, and the like. Example of the binder include polytetrafluoroethylene, styrene-butadiene rubber, vinylidene polyfluoride, and the like. Examples of the electrolyte solution include an alkaline aqueous solution in which a hydroxide of alkali metal such as potassium hydroxide, sodium hydroxide, lithium hydroxide, and the like is dissolved in water, the alkaline aqueous solution with zinc oxide added thereto, and the like. As the conductive aid, binder, electrolyte solution, and the like, those which have a conventional configuration can be used, and the mixed amounts thereof may be the same as those in the conventional example.

Next, zinc used as a negative active material in the present invention will be described. The battery characteristics of an alkaline battery are largely influenced by the particle size distribution of zinc powder used in a negative electrode. More specifically, in the case where the particle size of zinc power is large, the alkaline battery is excellent in storage characteristics with less generation of gas; however, heavy-load discharging characteristics are degraded. On the other hand, in the case where the particle size of zinc powder is small, the alkaline battery is likely to be corroded although being excellent in heavy-load discharging characteristics. When nickel oxyhydroxide is used for a positive electrode, storage characteristics are degraded, in particular. Therefore, the positive electrode composed of nickel oxyhydroxide cannot be combined with a negative electrode containing zinc that contains particles of 10 to 75 μm in an amount of 10 wt % or more. According to the present invention, the positive electrode composed of nickel oxyhydroxide can be combined with such a negative electrode, so that the heavy-load discharging characteristics of the alkaline battery can be enhanced further. By setting the proportion of zinc particles with a particle size of 10 to 75 μm to be 20 wt % or more, high-rate characteristics can be enhanced further, and it is more desirable to set the proportion to be 35 wt % or more. If the high-rate characteristics are given priority, the proportion of the above-mentioned particles may be set to be 100 wt %.

The above-mentioned zinc particles generally are produced by a gas atomize method. However, in order to obtain zinc particles with a predetermined particle size, it is convenient to sift the produced zinc particles. For example, if the zinc particles are classified with a 200-mesh sieve, zinc particles with a particle size of 75 μm or less can be obtained selectively. It is preferable that the zinc particle passing through the 200-mesh sieve are further classified with a finer sieve to remove minute particles with a particle size of less than 10 μm, and the remaining particles with a particle size of 10 to 75 μm are used for production of a negative electrode.

On the other hand, hydrogen gas is generated by the reaction between zinc and an electrolyte solution irrespective of the state of a positive electrode. Therefore, in order to minimize this reaction and keep the flowability of a mixture of a negative electrode to be satisfactory to enhance the productivity of the battery, the proportion of zinc particles with a particle size of 10 to 75 μm may be set to be 70 wt % or less, and more desirably 50 wt % or less. Furthermore, zinc particles with a particle size less than 10 μm generate more gas to adversely influence the storage characteristics, and makes it difficult to perform an electrical contact due to an oxide formed on the surface. This makes it difficult to contribute to the discharging reaction. Therefore, it is desirable to minimize such minute particles. In view of the balance between the high-rate characteristics and the storage characteristics, the average particle size of the zinc particles used in the present invention appropriately is set to be 80 to 200 μm.

Furthermore, in order to prevent the above-mentioned generation reaction of hydrogen gas from zinc, it is effective to allow at least one element such as indium, bismuth, aluminum, or the like to be contained in zinc. In particular, it is desirable that at least indium and bismuth are contained in zinc. The contents of these elements may be set to be 0.01 wt % or more for indium, 0.003 wt % or more for bismuth, and 0.0001 wt % or more for aluminum, with respect to added zinc. The contents of these elements preferably are set to be 0.03 to 0.07 wt % for indium, 0.007 to 0.07 wt % for bismuth, and 0.001 to 0.007 wt % for aluminum.

In the case where hydrogen is generated from a negative electrode, it is expected that nickel oxyhydroxide of a positive electrode is reduced to cause a decrease in capacity of a battery. However, as described above, nickel oxyhydroxide used in the present invention is covered with a cobalt compound, so that the reduction reaction of nickel oxyhydroxide due to hydrogen can be suppressed.

Furthermore, in order to configure the alkaline battery of the present invention, a separator, an electrolyte solution, and the like are required, and these may have a conventional configuration. As the electrolyte solution, in the same way as in those used for producing the above-mentioned positive electrode, for example, an alkaline aqueous solution composed of an aqueous solution of a hydroxide of alkaline metal such as potassium hydroxide, sodium hydroxide, lithium hydroxide, and the like, the alkaline aqueous solution with zinc oxide added thereto, and the like can be used. As the separator, for example, non-woven fabric mainly containing vinylon and rayon, vinylon-rayon nonwoven fabric, polyamide non-woven fabric, polyolefin-rayon non-woven fabric, vinylon paper, vinylon-linter pulp paper, vinylon-mercerized pulp paper, and the like can be used.

Next, embodiments of the present invention will be described specifically by way of examples. The present invention is not limited to the examples.

### EXAMPLE 1

First, nickel oxyhydroxide used in Example 1 was produced as follows.

Commercially available nickel hydroxide (produced by Tanaka Chemical Corporation) for a nickel hydrogen storage battery coated with a cobalt compound (cobalt oxyhydroxide), in which 3 wt % of zinc and 0.8 wt % of cobalt were dissolved in a solid state, and water were stirred in a reaction container, and sodium hypochlorite with an effective chlorine amount of 14 wt % was added to the mixture with stirring. The resultant mixture was stirred for 2 hours while being kept at 50° C. Thereafter, a reaction product was washed with water, filtered, and dried at 100° C. for 24 hours, whereby nickel oxyhydroxide was obtained in which 4 parts by weight of a cobalt compound (cobalt oxyhydroxide) in terms of a cobalt conversion were present on the surface with respect to 100 parts by weight of nickel oxyhydroxide.

The oxidation degree of the above-mentioned nickel oxyhydroxide was obtained by the following method. First, 0.2 g of the above-mentioned nickel oxyhydroxide, 1 g of potassium iodide, and 10 mL of 6 mol/L hydrochloric acid were placed in a 100 mL sample bottle with a lid, followed by stirring thoroughly. Then, the mixture was allowed to stand in a dark place for one hour. Thereafter, 10 mL of a buffer solution containing a mixture of 0.5 mol/L of acetic acid and 0.5 mol/L of ammonium acetate was added to the mixture, followed by stirring. Liberated iodine was titrated with 0.1 mol/L sodium thiosulfate solution, and 1 mL of 1 wt % starch aqueous solution was added in the vicinity of the final point. The titer of 0.1 mol/L sodium thiosulfate solution required until the final point was measured, and the measurement result was substituted into the following expression to calculate an oxidation degree.

Oxidation degree=2+[(V−B)×N]/10÷[M×(G/X+H/Y+I/Z)]

Herein, the oxidation degree represents an average valence of nickel in nickel oxyhydroxide, and each symbol in the above expression represents the following numerical value.

V(mL): Titer of sodium thiosulfate

B(mL): Titer of sodium thiosulfate required for titration, in a blank test performed without placing nickel oxyhydroxide

N(mol/L): Normality of sodium thiosulfate solution

M(g): Sample weight

G(wt %): Content of Ni in nickel oxyhydroxide

H(wt %): Content of Co in nickel oxyhydroxide

I(wt %): Content of Zn in nickel oxyhydroxide

X: Atomic weight of Ni (58.71)

Y: Atomic weight of Co (58.93)

Z: Atomic weight of Zn (65.37)

In nickel oxyhydroxide of Example 1, V:20.52 (mL), B:0.14 (mL), N: 0.1 (mol/L), M:0.2 (g), G:55.1 (wt %), H:4.8 (wt %), I:3 (wt %). The oxidation degree of nickel oxyhydroxide obtained by the above measurement was 2.95.

Next, the electric potential of nickel oxyhydroxide was measured in the following procedure. One-hundred parts by weight of the above-mentioned nickel oxyhydroxide, 10 parts by weight of 2 wt % carboxymethylcellulose aqueous solution, 20 parts by weight of water, and 1 part by weight of polytetrafluoroethylene dispersion with a concentration of a solid content of 60 wt % were mixed to prepare a paste. Athree-dimensional nickel foam was filled with the obtained paste, followed by drying. Then, a nickel line was spot-welded. The resultant foam was soaked in 32 wt % of KOH aqueous solution (alkaline electrolyte solution) containing 2.18 wt % of ZnO, and the electric potential of nickel oxyhydroxide was measured at room temperature with Hg/HgO being used as a reference electrode. Consequently, the electric potential was 0.340 V.

Next, 75 parts by weight of the above-mentioned nickel oxyhydroxide, 25 parts by weight of manganese dioxide having a BET specific surface area of 35 m²/g, 8 parts by weight of graphite, and 1 part by weight of polytetrafluoroethylene powder were dry-mixed with a planetary mixer. Then, 6 parts by weight of an alkaline aqueous solution containing 56 wt % of potassium hydroxide and 2.9 wt % of zinc oxide were added to the resultant mixture, followed by wet-mixing. The mixture thus obtained was crushed after being pressed, and further granulated to obtain a granule-shaped positive mixture. A mold was filled with the granule-shaped positive mixture for molding to obtain a cylindrical positive electrode. The positive electrode thus produced was measured for strength with a push-pull gauge under a pressure at a speed of 0.186 mm/sec.

Then, in production of the alkaline battery of Example 1, a gel negative electrode to be used in combination with the above-mentioned positive electrode was prepared as follows. First, a gel electrolyte solution used for preparing the gel negative electrode was prepared by adding 0.57 parts by weight of sodium polyacrylate and 0.35 parts by weight of polyacrylic acid to 47.2 parts by weight of an electrolyte solution composed of the above-mentioned alkaline aqueous solution, and allowing the mixture to stand overnight to form the mixture into a gel. Then, 100 parts by weight of zinc powder (average particle size: 100 μm) composed of 40 wt % of zinc particles with a particle size in a range of 10 to 75 μm and 60 wt % of zinc particles with a particle size larger than 75 μm and equal to or smaller than 500 μm, produced by a gas atomize method, were added to the gel electrolyte solution, followed by mixing, to obtain a gel negative electrode. The gel negative electrode thus obtained was defoamed for assembly of a battery.

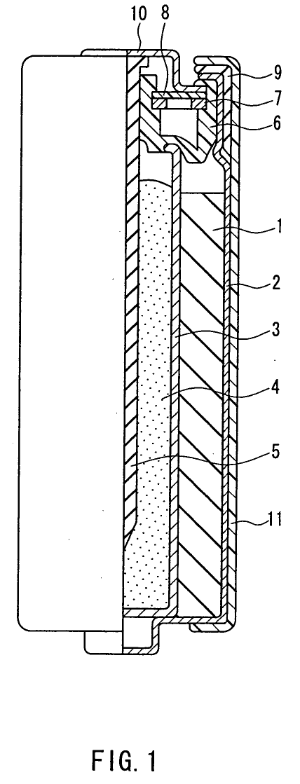

Then, the cylindrical positive electrode obtained as described above was inserted in an AA battery can. Thereafter, an acetalized non-woven fabric of vinylon, which was a known separator for an alkaline dry battery, was wound in a cylindrical shape, and placed so as to come into contact with the inside of the cylindrical positive electrode. Thereafter, an alkaline aqueous solution containing 32 wt % of potassium hydroxide and 2.18 wt % of zinc oxide was injected as an electrolyte solution so as to penetrate in fiber gaps of the separator completely. Then, a space on an inner circumferential side of the cylindrical separator was filled with the gel negative electrode, whereby an AA alkaline battery with the configuration shown in FIG. 1 was produced.

Hereinafter, the alkaline battery shown in FIG. 1 will be described. In FIG. 1, a positive electrode 1 is housed in a positive can 2 with a terminal, and an inner circumferential side of the positive electrode 1 in the positive can 2 was filled with a gel negative electrode 4 via a separator 3. Reference numerals 5 denotes a negative collector, 6 a sealing body, 7 a metal washer, 8 a resin washer, 9 an insulating cap, 10 a negative terminal plate, and 11 a resin outer body. The components described after the negative collector 5 have the same known configurations as those used in a conventional alkaline battery.

### EXAMPLE 2

Nickel oxyhydroxide was produced by the same method as that in Example 1, except that the drying condition in the drying process during production of nickel oxyhydroxide was set to be 100° C. for 15 hours. The oxidation degree and electric potential of the nickel oxyhydroxide thus obtained were obtained in the same way as in Example 1. As a result, the oxidation degree of the nickel oxyhydroxide was 2.96, and the electric potential thereof was 0.389 V with respect to an Hg/HgO reference electrode, which exceeded the range of the present invention.

In order to adjust the electric potential of the nickel oxyhydroxide, 100 parts by weight of nickel oxyhydroxide, and 6 parts by weight of an alkaline aqueous solution containing 56 wt % of potassium hydroxide and 2.9 wt % of zinc oxide were wet-mixed to obtain a mixture. The mixture thus obtained was stored at 45° C. for 20 days, and the electric potential and oxidation degree of the nickel oxyhydroxide were measured in the same way as in Example 1, using the mixture after storage. Consequently, the electric potential of the nickel oxyhydroxide was 0.360 V, and the oxidation degree thereof was 2.93. Thus, it was found that the electric potential of nickel oxyhydroxide can be adjusted by storage under the above condition.

Next, 75 parts by weight of the above-mentioned nickel oxyhydroxide exhibiting an electric potential of 0.389 V, 25 parts by weight of manganese dioxide, 8 parts by weight of graphite, and 1 part by weight of polytetrafluoroethylene powder were dry-mixed with a planetary mixer, and 6 parts by weight of an alkaline aqueous solution with the same composition as that of the obtained mixture was added to the mixture, followed by wet-mixing. The obtained mixture was crushed after being pressed, and granulated further to obtain a granule-shaped positive mixture. The positive mixture thus obtained was stored at 45° C. for 20 days, and a mold was filled with the positive mixture for molding to obtain a cylindrical positive electrode. The strength of the cylindrical positive electrode was measured in the same way as in Example 1. Furthermore, an AA alkaline battery was produced in the same way as in Example 1, using this positive electrode.

### EXAMPLE 3

A cylindrical positive electrode was produced in the same way as in Example 1, except for using 40 parts by weight of nickel oxyhydroxide and 60 parts by weight of manganese dioxide similar to those used in Example 1, and the strength thereof was measured. Furthermore, an AA alkaline battery was produced in the same way as in Example 1 using this positive electrode.

### EXAMPLE 4

Nickel oxyhydroxide was produced using nickel hydroxide in which only 4 wt % of cobalt was dissolved in a solid state and the surface was covered with cobalt oxyhydroxide. The same conditions as those in Example 1 were set, except that the drying condition after washing with water was set to be 80° C. for 15 hours, whereby nickel oxyhydroxide in which 4 parts by weight (in terms of cobalt conversion) of a cobalt compound was present on the surface with respect to 100 parts by weight of nickel oxyhydroxide was produced. The oxidation degree of the obtained nickel oxyhydroxide was 3.06, and the electric potential thereof was 0.328 V with respect to a Hg/HgO reference electrode.

A cylindrical positive electrode was produced in the same way as in Example 1, using the above nickel oxyhydroxide, and the strength thereof was measured. Furthermore, an AA alkaline battery was produced in the same way as in Example 1, using this positive electrode.

### EXAMPLE 5

An AA alkaline battery was produced in the same way as in Example 1, except for using a negative electrode that uses zinc powder having a particle size distribution in a range of 75 (exclusive) to 500 μm and an average particle size of 150 μm.

### COMPARATIVE EXAMPLE 1

A cylindrical positive electrode was produced in the same way as in Example 1, except that only 100 parts by weight of manganese dioxide having a BET specific surface area of 35 m²/g were used as a positive active material, without using nickel oxyhydroxide, and the strength thereof was measured. Furthermore, an AA alkaline battery was produced in the same way as in Example 1 using this positive electrode.

### COMPARATIVE EXAMPLE 2

In production of nickel oxyhydroxide, Nickel oxyhydroxide was produced in the same way as in Example 1, except for using nickel hydroxide in which zinc and cobalt were not dissolved in a solid state and the surface thereof was not coated with a cobalt compound. The oxidation of the nickel oxyhydroxide was 2.99, and the electric potential thereof was 0.410 V with respect to a Hg/HgO reference electrode.

Next, a cylindrical positive electrode was produced in the same way as in Example 1, except that only 100 parts by weight of the above nickel oxyhydroxide were used as an active material, and manganese dioxide was not mixed, and the strength thereof was measured. Furthermore, an AA alkaline battery was produced in the same way as in Example 1 using this positive electrode.

### COMPARATIVE EXAMPLE 3

A cylindrical positive electrode was produced in the same way as in Example 1, except for using a mixture of 25 parts by weight of nickel oxyhydroxide and 75 parts by weight of manganese dioxide similar to those in Example 1. Furthermore, an AA alkaline battery was produced in the same way as in Example 1 using this positive electrode.

### COMPARATIVE EXAMPLE 4

Nickel hydroxide in which 3 wt % of zinc and 0.8 wt % of cobalt were dissolved in a solid state, and water were stirred in a reaction container, and sodium hypochlorite with an effective chlorine amount of 14 wt % was added to the mixture with stirring. The resultant mixture was continued to be stirred for 2 hours while being kept at 50° C. Thereafter, a reaction product was washed with water, filtered, and dried at 80° C. for 15 hours, whereby nickel oxyhydroxide was obtained. The oxidation degree of nickel oxyhydroxide was 2.98, and the electric potential thereof was 0.396 V.

A cylindrical positive electrode was produced in the same way as in Example 1 using the above nickel oxyhydroxide, and the strength thereof was measured. Furthermore, an AA alkaline battery was produced in the same way as in Example 1 using this positive electrode.

Table 1 shows the measurement results of the electric potential, oxidation degree, mixed ratio with respect to manganese dioxide of nickel oxyhydroxide used as a positive active material, and the strength of a positive electrode, regarding the positive electrodes for an alkaline battery of Examples 1 to 4 and Comparative Examples 1 to 4.

TABLE 1

| | Physical | | | | |
|---|---|---|---|---|---|
| | properties of | | Mixed ratio of positive | | Strength |
| | nickel oxyhydroxide | | active material (wt %) | | of |
| | Electric | Oxida- | | Manga- | positive |
| | potential | tion | Nickel | nese | electrode |
| | (V) | degree | oxyhydroxide | dioxide | (N) |
| Example 1 | 0.340 | 2.95 | 75 | 25 | 6860 |
| Example 2 | 0.360 | 2.93 | 75 | 25 | 7056 |
| Example 3 | 0.340 | 2.95 | 40 | 60 | 7154 |
| Example 4 | 0.328 | 3.06 | 75 | 25 | 6850 |
| Comparative | — | — | 0 | 100 | 7200 |
| Example 1 | | | | | |
| Comparative | 0.410 | 2.99 | 100 | 0 | 4900 |
| Example 2 | | | | | |
| Comparative | 0.340 | 2.95 | 25 | 75 | 7252 |
| Example 3 | | | | | |
| Comparative | 0.396 | 2.98 | 75 | 25 | 6664 |
| Example 4 | | | | | |

Furthermore, regarding the alkaline batteries of Examples 1 to 5 and Comparative Examples 1 to 4, the pulse discharging characteristics, open-circuit voltage (OCV), OCV after storage at a high temperature, and storage characteristics were checked under the following conditions.

(Pulse Discharging Characteristics)

Under a temperature condition of 23° C., pulse discharging for flowing a pulse current of 2 A for 2 seconds was performed at an interval of 30 seconds, and the number of pulse discharging required for the voltage of a battery to decrease to 1.0 V while the pulse current of 2 A was flowing was measured. This measurement was performed with respect to 10 batteries in each example, and an average value thereof was obtained as pulse discharging characteristics, which were used for evaluating heavy-load discharging characteristics.

(OCV)

The voltages of 10 batteries were measured under a temperature condition of 23° C., and an average thereof was obtained.

(Storage characteristics)

A battery that has not been discharged was discharged continuously with a current value of 1 A under a temperature condition of 23° C., and a discharging time required for the voltage of the battery to reach 0.9 V was measured. This measurement was performed with respect to 10 batteries in each example, and an average time was obtained as a discharging time before storage.

Next, batteries that were measured for the above OCV and that have not been discharged was stored in a homoiothermal chamber at 60° C. for 20 days, and cooled at room temperature for one day after being taken out of the homoiothermal chamber. The voltages of the batteries under a temperature condition of 23° C. were measured. An average value of the voltages of 10 batteries was set to be as OCV after storage at a high temperature.

Then, the batteries were discharged continuously with a current value of 1 A in the same way as the above to measure a discharging time, and an average discharging time of 10 batteries was set to be as a discharging time after storage. The ratio of the discharging time after storage with respect to the discharging time before storage was obtained as a capacity retention ratio, and the storage characteristics of the batteries were evaluated. Table 2 shows the measurement results.

TABLE 2

| | | | Pulse | |
|---|---|---|---|---|
| | | | discharging | |
| | | | characteristics | Storage |
| | | | Number of | characteristics |
| | OCV (V) | | discharging | Capacity |
| | Before | | (Number of | retention ratio |
| | storage | After storage | times) | (%) |
| Example 1 | 1.730 | 1.705 | 195 | 76 |
| Example 2 | 1.738 | 1.710 | 198 | 78 |
| Example 3 | 1.726 | 1.702 | 165 | 79 |
| Example 4 | 1.735 | 1.712 | 195 | 65 |
| Example 5 | 1.730 | 1.712 | 130 | 84 |
| Comparative | 1.644 | 1.613 | 75 | 77 |
| Example 1 | | | | |
| Comparative | 1.770 | 1.730 | 150 | 50 |
| Example 2 | | | | |
| Comparative | 1.715 | 1.693 | 115 | 80 |
| Example 3 | | | | |
| Comparative | 1.779 | 1.724 | 150 | 45 |
| Example 4 | | | | |

As shown in Table 1, the positive electrodes in Examples 1 to 4 contained a combination of nickel oxyhydroxide and manganese dioxide, so that they had high strength and were excellent in a handling property. Furthermore, as shown in Table 2, in the alkaline batteries (Examples 1 to 5) using the above-mentioned positive electrode, the number of pulse discharging was 130 or more, so that they were excellent in pulse discharging characteristics (heavy-load discharging characteristics). Particularly, in the alkaline batteries of Examples 1 to 4 including a combination of the above-mentioned positive electrode and a zinc negative electrode that contains minute particles (particle size: 10 to 75 μm) in an amount of 10 wt % or more, the number of pulse discharging was 150 or more, so that they exhibited very satisfactory heavy-load discharging characteristics.

Thus, in order to allow the positive electrode of the present invention to exhibit its features, it is desirable to combine the positive electrode with a negative electrode containing minute zinc particles in a predetermined amount or more. Furthermore, in Examples 1 to 5, manganese dioxide with a BET specific surface area of 35 m²/g was used. It may be possible to further enhance the heavy-load discharging characteristics, using manganese dioxide with a BET specific surface area enlarged by being doped with titanium or zirconium. Furthermore, by further increasing the proportion of zinc particles with a particle size of 10 to 75 μm, the heavy-load discharging characteristics can be enhanced further. By optimizing a positive electrode and a negative electrode, a battery can be configured in which the above-mentioned number of pulse charging is 300 or more.

On the other hand, the decrease in OCV by storage at a high temperature of the batteries of Examples 1 to 5 was small (i.e., 30 mV or less), so that they also were excellent in storage characteristics. Particularly, in the batteries of Examples 1 to 3 with an oxidation degree suppressed and an average valence of nickel decreased, the storage characteristics equal to those of a conventional alkaline battery (Comparative Example 1) using manganese dioxide were exhibited.

In contrast, the battery of Comparative Example 2 was not covered with a cobalt compound, and used nickel oxyhydroxide particles with an electric potential higher than 0.375 V as a positive active material. Therefore, this battery was poor in pulse discharging characteristics and storage characteristics, compared with those of Examples 1 to 4. Furthermore, the positive electrode of Comparative Example 2 was not mixed with manganese dioxide, so that the strength thereof was decreased, compared with those of Examples 1 to 4.

Furthermore, although the battery of Comparative Example 3 used nickel oxyhydroxide as a positive active material, its proportion was less than 35 wt %, so that the pulse discharging characteristics of this battery were remarkably decreased, compared with those of Examples 1 to 4. Furthermore, in the battery of Comparative Example 4, the electric potential of nickel oxyhydroxide was too high, so that the storage characteristics of this battery were unsatisfactory.

As described above, by configuring an alkaline battery using a positive electrode containing 35 wt % or more of nickel oxyhydroxide, which is covered with a cobalt compound and whose electric potential is adjusted to be in a range of 0.320 to 0.375 V with respect a Hg/HgO reference electrode, in an positive active material, an alkaline battery can be provided, which is excellent in heavy-load discharging characteristics and storage characteristics, and keeps excellent heavy-load discharging characteristics even after storage at a high temperature. Particularly, in the case where a negative electrode containing minute zinc particles in a predetermined proportion or more is combined with the above-mentioned positive electrode, the effect can be exhibited remarkably.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A positive electrode for an alkaline battery, comprising:
a positive active material comprising nickel oxyhydroxide; and
a cobalt compound disposed on a surface of the nickel oxyhydroxide, wherein an electric potential of the nickel oxyhydroxide is in a range of 0.320 to 0.375 V with respect to a Hg/HgO reference electrode, and wherein the nickel oxyhydroxide is at least 35 wt % of the positive active material.

2. The positive electrode for an alkaline battery according to claim 1, wherein a content of the nickel oxyhydroxide in the positive electrode is at most 95 wt % with respect to the positive active material.

3. The positive electrode for an alkaline battery according to claim 2, the positive active material further comprising manganese dioxide.

4. The positive electrode for an alkaline battery according to claim 1, further comprising a solid solution formed by the nickel oxyhydroxide with 0.01 to 5 wt % of zinc.

5. The positive electrode for an alkaline battery according to claim 1, further comprising a solid solution formed by the nickel oxyhydroxide with 0.01 to 2 wt % of cobalt.

6. The positive electrode for an alkaline battery according to claim 1, wherein an amount of the cobalt compound present on the surface of the nickel oxyhydroxide is 0.5 to 8 parts by weight in terms of cobalt conversion with respect to 100 parts by weight of the nickel oxyhydroxide.

7. The positive electrode for an alkaline battery according to claim 1, wherein an electric potential of the nickel oxyhydroxide is at least 0.330 V with respect to a Hg/HgO reference electrode.

8. The positive electrode for an alkaline battery according to claim 7, wherein an electric potential of the nickel oxyhydroxide is at least 0.340 V with respect to a Hg/HgO reference electrode.

9. The positive electrode for an alkaline battery according to claim 1, wherein an electric potential of the nickel oxyhydroxide is at most 0.360 V with respect to a Hg/HgO reference electrode.

10. The positive electrode for an alkaline battery according to claim 1, wherein an electric potential of the nickel oxyhydroxide is 0.340 to 0.360 V with respect to a Hg/HgO reference electrode.

11. A positive electrode for an alkaline battery, comprising:
a positive active material comprising nickel oxyhydroxide and manganese dioxide;
a solid solution formed by the nickel oxyhydroxide with 0.01 to 5 wt % of zinc and 0.01 to 2 wt % of cobalt, a cobalt compound covering a surface of the nickel oxyhydroxide in an amount of 0.5 to 8 parts by weight in terms of cobalt conversion with respect to 100 parts by weight of nickel oxyhydroxide, wherein an electric potential of the nickel oxyhydroxide is in a range of 0.330 to 0.375 V with respect to a Hg/HgO reference electrode, and a content of the nickel oxyhydroxide in the positive electrode is in a range of 35 to 95 wt % with respect to the positive active material.

12. An alkaline battery comprising a negative electrode comprising a negative active material comprising zinc and a positive electrode comprising a positive active material comprising nickel oxyhydroxide,
wherein the zinc of the negative electrode contains at least 10 wt % of particles with a particle size of 10 to 75 μm,
a cobalt compound covering a surface of the nickel oxyhydroxide of the positive electrode,
an electric potential of the nickel oxyhydroxide is in a range of 0.320 to 0.375 V with respect to a Hg/HgO reference electrode, and
a content of the nickel oxyhydroxide in the positive electrode is at least 35 wt % with respect to the positive active material.

13. The alkaline battery according to claim 12, wherein a content of the nickel oxyhydroxide in the positive electrode is at most 95 wt % with respect to the positive active material.

14. The alkaline battery according to claim 13, the positive active material further comprising manganese dioxide.

15. The alkaline battery according to claim 12, further comprising a solid solution formed by the nickel oxyhydroxide with 0.01 to 5 wt % of zinc.

16. The alkaline battery according to claim 12, further comprising a solid solution formed by the nickel oxyhydroxide with 0.01 to 2 wt % of cobalt.

17. The alkaline battery according to claim 12, wherein an amount of the cobalt compound present on the surface of the nickel oxyhydroxide is 0.5 to 8 parts by weight in terms of cobalt conversion with respect to 100 parts by weight of the nickel oxyhydroxide.

18. The alkaline battery according to claim 12, wherein an electric potential of the nickel oxyhydroxide is at least 0.330 V with respect to a Hg/HgO reference electrode.

19. The alkaline battery according to claim 18, wherein an electric potential of the nickel oxyhydroxide is at least 0.340 V with respect to a Hg/HgO reference electrode.

20. The alkaline battery according to claim 12, wherein an electric potential of the nickel oxyhydroxide is at most 0.360 V with respect to a Hg/HgO reference electrode.

21. The alkaline battery according to claim 12, wherein an electric potential of the nickel oxyhydroxide is 0.340 to 0.360 V with respect to a Hg/HgO reference electrode.

22. The alkaline battery according to claim 12, wherein a proportion of the zinc particles with a particle size of 10 to 75 μm is at least 35 wt %.

23. The alkaline battery according to claim 12, wherein a proportion of the zinc particles with a particle size of 10 to 75 μm is at most 70 wt %.

24. The alkaline battery according to claim 23, wherein a proportion of the zinc particles with a particle size of 10 to 75 μm is 20 to 50 wt %.

25. The alkaline battery according to claim 12, wherein the zinc of the negative electrode comprises indium and bismuth.

26. The alkaline battery according to claim 14, wherein the manganese dioxide has a BET specific surface area of 40 to 100 m²/g.

27. The alkaline battery according to claim 14, wherein the manganese dioxide comprises 0.01 to 3 wt % of titanium or zirconium.

28. An alkaline battery comprising a negative electrode comprising a negative active material comprising zinc and a positive electrode comprising a positive active material comprising nickel oxyhydroxide,
wherein the zinc of the negative electrode comprises at least 20 wt % of particles with a particle size of 10 to 75 μm,
an electric potential of the nickel oxyhydroxide is in a range of 0.320 to 0.375 V with respect to a Hg/HgO reference electrode, and
a content of the nickel oxyhydroxide in the positive electrode is 35 to 95 wt % with respect to the positive active material.

29. The alkaline battery according to claim 28, wherein a proportion of the zinc particles with a particle size of 10 to 75 μm is at most 50 wt %.

30. The alkaline battery according to claim 28, further comprising manganese dioxide comprising a positive active material comprising 0.01 to 3 wt % of titanium or zirconium.

31. An AA alkaline battery comprising a negative electrode comprising a negative active material comprising zinc and a positive electrode comprising a positive active material comprising nickel oxyhydroxide,
wherein pulse discharging for flowing a pulse current of 2 A for 2 seconds is performed at an interval of 30 seconds at 23° C., a number of pulse discharging required for a voltage of the battery to decrease to 1.0 V while a pulse current of 2 A is flowing is at least 130, and a decrease in voltage is at most 30 mV when the battery is stored in a homoiothermal chamber of 60° C. for 20 days.
